(19) United States
(12) Patent Application Publication
(10) Pub. No.: US 2009/0187444 A1
(43) Pub. Date: Jul. 23, 2009

(54) Service knowledge map

(76) Inventor: Yefim Zhuk, Englewood, CO (US)

Correspondence Address: Yefim Zhuk, 11191 East Ida Place, Englewood, CO, 80111, US

(21) Appl. No.: 12/075,290

(22) Filed: Mar. 11, 2008

Related U.S. Application Data
(60) Provisional application No. 60/928,834, filed on May 11, 2007.

(51) Int. Cl. G06Q 30/00; G06F 3/00

(52) U.S. Cl. 705/7; 715/751; 705/1

(57) ABSTRACT

The Service Knowledge Map or Service Knowledge Bus will help developers and subject matter experts (SME) describe, find, assemble, and execute software services.

The main difference between this system and similar purpose systems is the target audience and related methods of communications. While similar systems target computer programs that can read and understand XML messages to connect web services, this system operates with natural language, providing mapping between service descriptions and implementations, and allows computerized systems and multiple audiences of SME for conversational flexibility while describing and assembling new services on-the-fly as well as creating sophisticated policy for service usage.

### DESCRIPTION SUMMARY

1. The invention will help to collect information on software products and services; will allow computer programs, developers, and subject matter experts to assemble services on-the-fly and provide distributed service execution based on negotiations and polices by service owners and consumers.

2. The system will capture and extend criteria (set of rules) to classify software products from multiple points of view including business, data, and design pattern perspectives. The system will unify development and business views with ontology representations.

3. The system will provide a conversational interface to create and change business requirements while assembling services.

4. The system will translate business requirements into services scenarios with ontology expressions, and provide an engine to execute these scenarios.

### References

1. Integration-Ready Architecture and Design, Cambridge University Press, Jeff Zhuk

### References Cited: U.S. Patent Documents

1. Telecommunication service registry, U.S. Pat. No. 7,243,155, Issued on Jul. 10, 2007

2. Integrated full service consumer banking system and system and method for opening an account, U.S. Pat. No. 6,131,810, Issued on Oct. 17, 2000

### BRIEF DESCRIPTION OF THE DRAWINGS

The drawings described below are for illustration purposes only and are not intended to limit the scope of the present disclosure in any way.

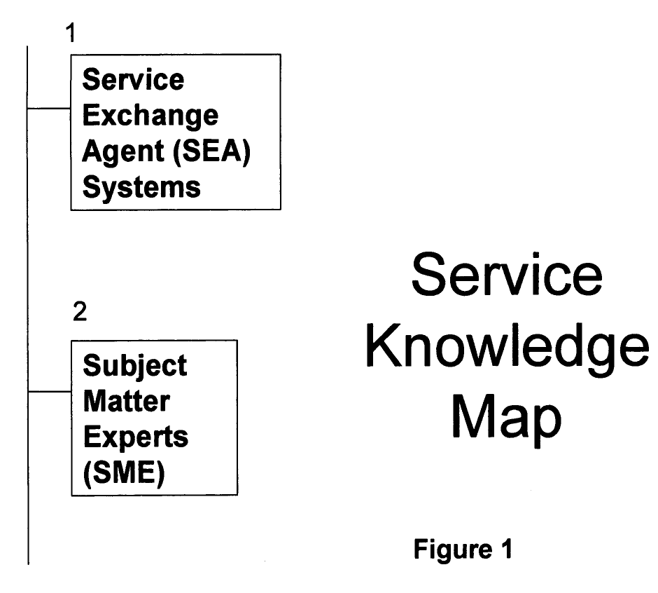

The FIG. 1 represents Service Knowledge Map that connects multiple Service Exchange Agent (SEA) systems and Subject Matter Experts (SME).

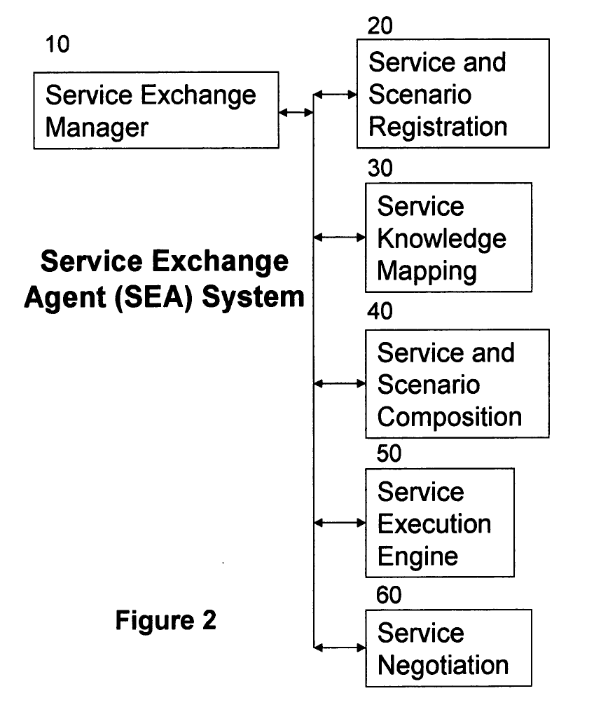

The FIG. 2 is a component diagram of the Service Exchange Agent system

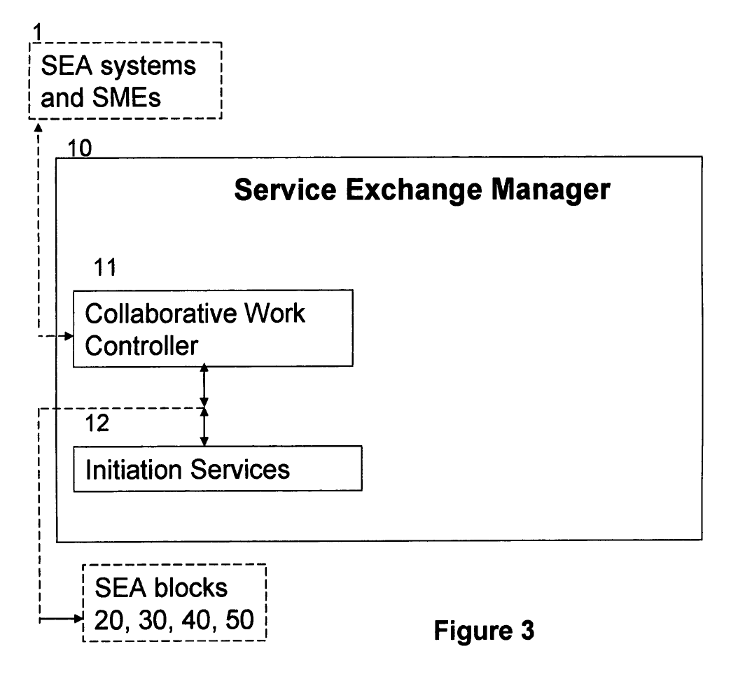

The FIG. 3 is a component diagram of the Service Exchange Manager

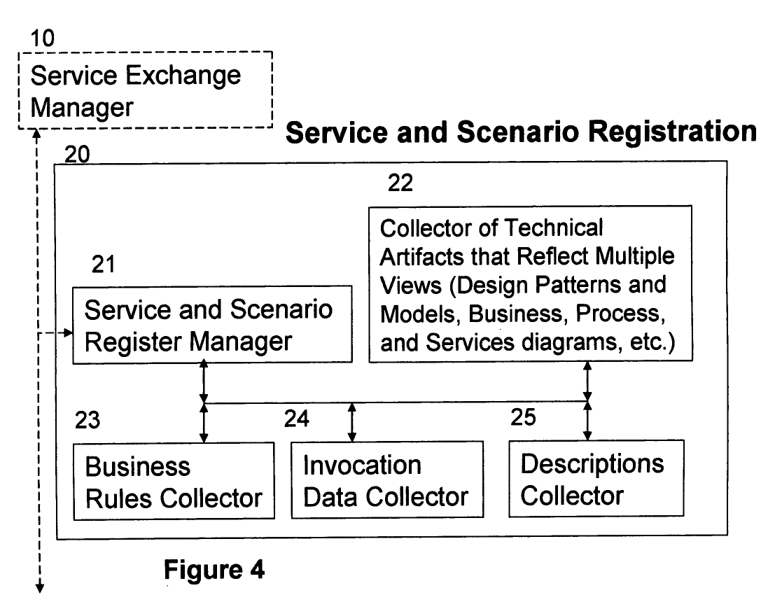

The FIG. 4 is a component diagram of the Service and Scenario Registration block

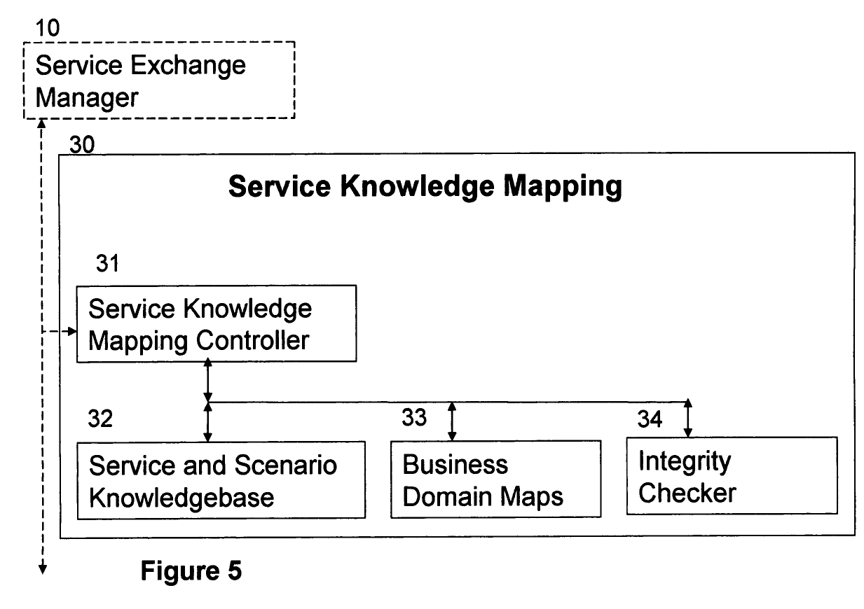

The FIG. 5 is a component diagram of the Service Knowledge Mapping block

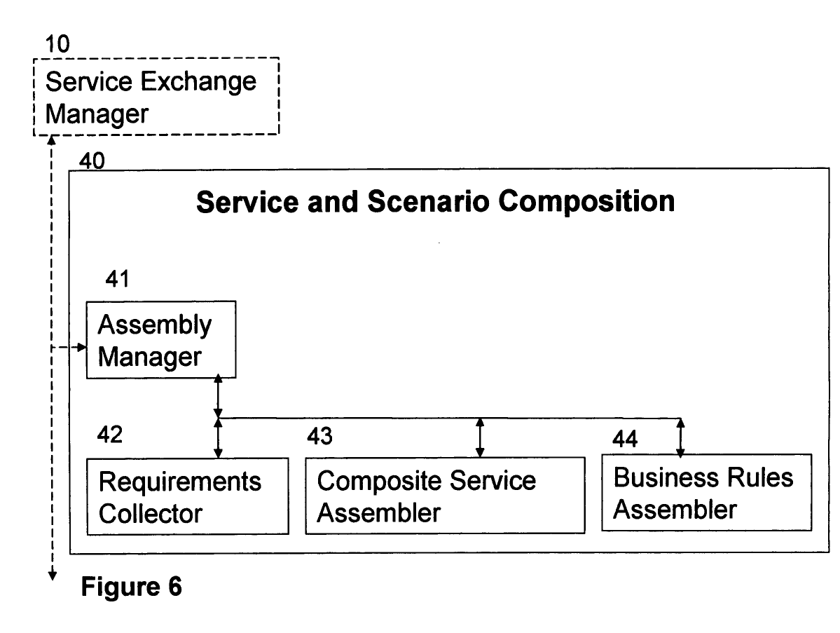

The FIG. 6 is a component diagram of the Service and Scenario Assembly block

### DETAILED DESCRIPTIONS

This invention introduces the Service Exchange Agent (SEA) systems that will help both audiences: computer programs and subject matter experts (SME) in a similar way, while playing roles of a service registry and service consumer at the same time. The SEA systems can operate with natural language, providing mapping between service descriptions and implementations. Collected by the system service descriptions include different technical and text artifacts, like design patterns, data and process architecture models, and etc. to reflect multiple views for multiple audiences.

Using common initiation services, SEA systems establish high level protocol for service exchange and provide structured access to services in multiple business domains. SEA systems can converse with each other and with SMEs while assembling and executing new composite services on-the-fly and creating sophisticated policies for service usage.

The following description serves as an example and is not intended to limit the present disclosure, application, or uses.

Turning to FIG. 1, the present system connects plurality of Service Exchange Agent (SEA) systems, 1, and subject matter experts (SME), 2. Each SEA system, 1, accumulates and serve services related to one or more business domains. While the SEA system, 1, has full knowledge about their own services, each SEA system, 1, also has meta-data related to all other systems. This meta-data include but not limited to other SEA system locations and their specialties or business domains. With this knowledge multiple SEA systems can successfully collaborate while responding to complex requests. The SEA systems that locate requested services will be included in a collaborative work, for example, performing a composite service scenario, and one of the SEA systems with smallest load will play a coordinator role.

Turning to FIG. 2, the SEA system, 1, may include but is not limited to Service Exchange Manager, 10, Service and Scenario Registration block, 20, Service Knowledge Mapping block, 30, Service and Scenario Composition block, 40, Service Execution Engine, 50, and Service Negotiation block, 60.

The SEA system enables the service exchange that might include but not limited by service offering, registration, subscription, and execution, consumption, and composition, as well as negotiation of service terms. In the process of service exchange, the SEA system interacts with other SEA systems and multiple audiences of developers, business analysts, and other subject matter experts, that will be called SME in the following description. The SEA system enables structured navigation across business domains and service descriptions, like business and system requirements provided with human readable language as well as with XML, architecture diagrams and models, design patterns and other technical artifacts, which in the future we'll call “technical artifacts”.

Service Exchange Manager, 10, enables initiation of and responses to communication requests related to service exchange.

Service Exchange Manager, 10, interacts with Service and Scenario Registration block, 20, in the process of registration, arranging a dialog with another SEA system, 1, or SME, 2, which announced the service or scenario for registration. In this case, another SEA system, 1, or SME, 2, act in the process of service or scenario offering. A scenario is a composite service that might include service calls as well as business rules and in some cases can represent an application. In the future, we'll use the “service” term to represent both: service and/or scenario.

During the dialog the Service Exchange Manager, 10, will make best efforts to retrieve information describing the service from multiple points of view for multiple audiences and deliver this information to the Service and Scenario Registration block, 20.

In the process of registration, Service Exchange Manager, 10, also interacts with Service Knowledge Mapping block, 30, which creates and stores associations between multiple information views related to a service and existing knowledgebase of associations. Associations or maps are started from the business domain level and continued in multiple other (not only hierarchical) directions, while enabling connections between text semantics and technical artifacts.

At the end of the registration process, the Service Exchange Manager, 10, prompts the registrar for service negotiation terms, for example service value range and special conditions, and communicates this data to the Service Negotiation block, 60. The Service Exchange Manager, 10, also sends some meta-data, for example, keywords and key features, describing the newly registered service to all SEA systems and prompts all SEA systems to provide estimated value for this service.

The Service Negotiation block, 60, in each SEA system, keeps track of multiple service requests and calculates service values based on demand and service terms provided by a registrar. The value and terms might be a subject to negotiations during the request for service consumption.

Service Knowledge Mapping block, 30, provides information integrity and completeness check, which is reported to Service Exchange Manager, 10, and might result in additional dialog with SEA system, 1, or SME, 2, to retrieve more or correct existing data related to a registered service.

Integrity check may point out to a conflict between new and existing information. In this case, Service Exchange Manger, 10, will initiate dialogs with several SEA systems and/or SME, which are registered as owners of services with conflicting data. These dialogs will include auto-generated questions with the focus on conflicting data and the answers will be going via integrity check. Conflict resolving dialogs might take several cycles until conflict is resolved or predefined number of cycles is exhausted.

In the process of service composition, Service Exchange Manager, 10, supports communications with a SEA system, 1, or SME, 2, composition requester, and interacts with Service Composition block, 40, to compose a new service or an application on demand. The Service Exchange Manager, 10, passes initial composition data from the requestor to the Service Composition block, 40, and to the Service Knowledge Mapping block, 30, looking for information related to existing services mapped by the Service Knowledge Mapping block, 30.

The Service Composition block, 40, collects initial composition data provided by a requester as initial service requirements and interacts with the Service Knowledge Mapping block, 30, to resolve requirements into names of existing services and business rules. The Service Composition block, 40, will report to the Service Exchange Manager, 10, success or failure of the composition.

If requirements cannot be resolved within the current SEA system, the Service Exchange Manager, 10, will broadcast the request for existing services to other SEA systems. In the case of positive response from SEA systems with the references to existing services, proper references will be added to a scenario formed by the Service Composition block, 40.

If a composite service scenario cannot be completed based on initial requirements, the Service Exchange Manager, 10, will prompt a requestor for additional information with the focus on unresolved parts of initial requirements. This will start another iteration of a service composition and will last till completion or requester exhausted the limit of iterations. In the latter case, the requestor will be given the option to save current state of requirements and composition work for future reuse.

The Service Exchange Manager, 10, can receive a request for service execution from a SME, or another SEA system, or from a subscription service, one of initiation services within the Service Exchange Manager, 10.

Turning to FIG. 3, the Service Exchange Manager, 10, may include, for example, but is not limited to the Collaborative Work Controller, 11, and the Initiation Services block, 12.

The Collaborative Work Controller, 11, enables conversations between SEA systems and SMEs and supports internal SEA interactions during service initiation, consumption, assembly, and execution.

The Initiation Services, 12, include but not limited by basic services that provide structured access to services in multiple business domains, like “List Services”, “Search for a Service”, “Subscribe to a Service”, “Load a Service”, “Execute a Service”, “Assemble a new service”, “Register a Service”, etc.

Initial Services, 12, interact with the Collaborative Work Controller, 11, that enables a conversation between a requestor and a responder, while initiating a service request or responding to an initial service request coming from a SME or another SEA system.

For example, the Initial Services, 12, like “List Services”, in collaboration with the Collaborative Work Controller, 11, will converse with a requester to narrow down the area of requestor interests, starting from business domain names. The conversation will reveal the main interest factors that might include service requirements, design patterns, or other business or technical considerations captured in the Service Knowledge Map. It is also possible that a requester selects the “List All Services in Alphabetical Order”, one of the first options offered during the conversation.

Another example is the Subscription Service. The Subscription Service will require the Customer Data including desired service execution location, Service Data, and Scheduling. The Subscription might also include some specific data, for example agreement related information. All these parameters will be retrieved during the conversation that will be managed by the Collaborative Work Controller, 11.

If a requested service is a complete scenario that consists of many services is not necessary present within a single SEA system, 1. In this case, the Service Exchange Manager, 10, will broadcast the request to the network of SEA systems. The SEA systems that locate requested services will be included in a collaborative work, for example, performing a composite service scenario, and one of the SEA systems with smallest load will play a coordinator role. The SEA coordinator will initiate and support conversations to other systems including terms negotiations, if necessary, to provide end-to-end service to a requestor.

Turning to FIG. 4, the Service and Scenario Registration block, 20, may include, for example, but is not limited to the Service and Scenario Register Manager, 21, Collector of Technical Artifacts that Reflect Multiple Views, like Design Patterns and Models, Business, Process, and Services diagrams, etc., 22, Business Rules Collector, 23, Invocation Data Collector, 24, and Descriptions Collector, 25.

The collection process can be initiated by a SME or a SEA system with the “Register a Service” initiation service, usually after a new service was assembled or loaded from outside of the system.

Each collector block, 22-25, includes certain messages, forms, rules, and criteria to enable collection of related data via conversational dialog with a party that register a service or a scenario.

The Service and Scenario Register Manager, 21, interacts with collector blocks, 22-25, and with the Service Exchange Manager, 10, that enables the conversation with a party that registers a service or a scenario. Each collector block checks collected data against block's rules and criteria and interacts with the Service Knowledge Mapping block, 30, for data interpretation, translation into proper formats, for example, into formatted business rules, and association or mapping data to a registered service. In the case of inconsistency or rule violation the collector block reports a problem back to the Service and Scenario Registration Manager, 21. In this case, the Service and Scenario Registration Manager, 21, interacts with the Service Knowledge Mapping block, 30, and the Service Exchange Manager, 10, to generate and send to the registrar party a more precise message that focuses on the problem data. This data retrieving cycle can be repeated a pre-determined number of times or until correct information is collected.

The Service and Scenario Registration Manager, 21, will send valid data to the Service Knowledge Mapping block, 30, where different types of data, business and technical nature, will be associated to a registered service.

Turning to FIG. 5, the Service Knowledge Mapping block, 30, enables association or mapping of multiple types of data to a related service or a scenario. The Service Knowledge Mapping block, 30, may include, for example, but is not limited to the Service Knowledge Mapping Controller, 31, the Service and Scenario Knowledgebase, 32, the Business Domain Maps, 33, and the Integrity Checker, 34.

The Service Knowledge Mapping Controller, 31, enables interaction between the Service and Scenario Knowledgebase, 32, the Business Domain Maps, 33, and the Integrity Checker, 34, and major SEA system blocks, 10, 20, 40, and 50. The Service and Scenario Knowledgebase, 32, enables storage of service descriptions and multiple other artifacts, and provides their mapping with natural language based associative rules. The Service and Scenario Knowledgebase, 32, in collaboration with the Service Knowledge Mapping Controller, 31, and the Service Exchange Manager, 10, enables conversational dialog with natural language elements between the SEA system, 1, and a SME, 2, or other SEA systems.

The Business Domain Maps block, 33, is an example of specific data set that defines business domains of registered services. Initiation Services, like “List Services” or “Search for a Service” will use this block to start listings with business domains or quickly find out if a requested service belongs to a requested business area.

The Business Domain Maps, 33, include meta-data about all SEA systems and any new registered service will propagate its name, business domain name, and brief descriptions to the Business Domain Maps, 33, in all SEA systems. This distribution of knowledge increases reliability of the overall system.

The Integrity Checker, 34, checks for association consistency. The Integrity Checker, 34, is triggered each time when a new rule or association is stored. If one association or a rule is in conflict with another association or a rule, the Integrity Checker, 34, reports to the Service Knowledge Mapping Controller, 31, and back to the Service Exchange Manager, 10, which will communicate to another party a message that will focus on a problem area to retrieve more data to resolve a conflict.

Turning to FIG. 6, the Scenario and Service Composition block, 40, may include, for example, but is not limited to, the Assembly Manager, 41, the Requirements Collector, 42, the Composite Service Assembler, 43, and the Business Rules Assembler, 44.

The Service and Scenario Composition block, 40, serves, for example, the “Assemble a new service” request from a SME, 2, or one of the SEA systems, 1. Upon such a request the Service and Scenario Composition block, 40, will collaborate with the Service Exchange Manager, 10, to arrange a conversational dialog to a requestor to retrieve requirements that might consist of text descriptions, design pattern names, and other technical artifacts. During the dialog, the Service and Scenario Composition block, 40, will also interact with the Service Knowledge Mapping block, 30, trying to interpret and map each sentence of the requirements to existing services or into business rules. As a result of this work, a new composite service or a scenario with its own set of rules will be stored and registered in the SEA system, and meta-data related to this new scenario will be propagated to the network for all SEA systems.

For example, in the requirements, there could be a sentence:
A user must login first to the system

The Service Knowledge Mapping block, 30, will interpret and map this sentence to an existing authentication service. To verify this mapping, the Service and Scenario Composition block, 40, in collaboration with the Service Exchange Manager, 10, will send the message to a requestor asking for a confirmation:
A user will invoke the Authentication Service.
Please confirm!

A requester, a human being, or a SEA system, 1, armed with the Service Knowledge Mapping block, 30, will recognize the semantic connection and confirm the message.

The Assembly Manager, 41, enables interactions between the Requirements Collector, 42, the Composite Service Assembler, 43, the Business Rules Assembler, 44, and other blocks of the SEA system, 1, like the Service Exchange Manager, 10, and the Services Knowledge Mapping block, 30.

The Composite Service Assembler, 43, enables transformation of original data coming from a requestor and mapped data coming from the Service Knowledge Mapping block, 30, into properly formatted scenario that can be later executed by the Service Execution Engine, 50. The scenarios usually have references to business rules assembled by the Business Rules Assembler, 44.

The Business Rules Assembler, 44, enables transformation of original data coming from a requestor and mapped data coming from the Service Knowledge Mapping block, 30, into properly formatted business rules that can be understood by the Service Execution Engine, 50, while performing the service execution.

The Requirements Collector, 42, in collaboration with the Assembly Manager, 41, enables collection of requirements and interacts with the Composite Service Assembler, 43, and the Business Rules Assembler, 44, while separating description information from invocation data that will be used and formatted by the Composite Service Assembler, 43, and business rules that will be used and formatted by the Business Rules Assembler, 44.

In the process of this interaction, the Composite Service Assembler, 43, and the Business Rules Assembler, 44, will parse incoming information to format service calls and rules for the resulting service scenario according to specifications understood by the Service Execution Engine, 50.

For example, the Composite Service Assembler, 43, will receive the requirements sentence below:
A user will invoke the Authentication Service.

The Composite Service Assembler, 43, will format this sentence into the lines, like below:

<prompt msg=“Your Login Name:” result=“$LoginName”/>
<prompt msg=“Your Password:” result=“$Password”/>
<service name=“AuthenticationService($LoginName, $Password)”
result=“$UserID”/>

In the case when incoming information is not quit ready for such transformation and formatting, the Composite Service Assembler, 43, will initiate another cycle of interaction with the requestor with a message that tries to clear up requirements to the degree that can requirements can be resolved sentence by sentence into well formatted service scenario lines.

The Business Rules Assembler, 44, will receive its portion of information related to business logic from the Requirements Collector, 42, and will also transform and format this information into rules according to the specification understood by the Service Execution Engine, 50.

The Service Execution Engine, 50, serves, for example, the “Execute a Service” request from a SME, 2, or one of the SEA systems, 1. Upon such a request the Service Execution Engine, 50, will collaborate with the Service Exchange Manager, 10, to receive information about a service or scenario for execution. If not all information was supplied with the execution request, the Service Execution Engine, 50, will arrange a conversational dialog to a requestor to retrieve necessary data, like a scenario to execute or a URL to such a scenario.

The Service Execution Engine, 50, will parse the scenario and interact with the Service Knowledge Mapping block, 30, to resolve scenario fragments into service calls and business logics, while replacing run-time variables, like, $LoginName, or $UserId, with run-time values.

Due to distributed nature of services, some of service invocations might be executed at other SEA systems, while the Service Execution Engine, 50, of the main SEA system, which intercepted the execution request, will supply necessary run-time parameters and receive resulting values.

The Service Negotiation block, 60, stores service terms, including desired service value range, provided by a registrar. The Service Negotiation block, 60, also keeps track of all service requests and calculates service values based on demand and service terms. The value and terms might be a subject to negotiations during the request for service consumption. The Service Negotiation block, 60, interacts with the Service Exchange Manager, 10, and enables terms negotiations. If automatic negotiations of terms between SEA systems are not successful, after pre-defined number of negotiation cycles, the SEA coordinator system will send a request to subject matter experts to participate and resolve the issues.

1. The Service Knowledge Map or Service Knowledge Bus comprising plurality of the Service Exchange Agent (SEA) systems connected via network and enabling collaboration and exchange of services and service scenarios.

2. The Service Exchange Agent system of claim 1 further comprising the Service Exchange Manager that enables conversational communications between Service Exchange Agent systems as well as subject matter experts, while enabling exchange and collaboration of services and service scenarios.

3. The Service Exchange Agent system of claim 1 further comprising the Service and Scenario Registration block, which enables:
registration of services and service scenarios;
conversation via the Service Exchange Manager with a registrar Service Exchange Agent system or a subject matter expert while collecting technical and non-technical artifacts describing a service or a scenario from multiple view points for multiple audiences, like developers, business analysts and other subject matter experts, which might include but is not limited by: requirements, design patterns, data, process, and architecture model diagrams and descriptions, invocation data, specific service agreement and negotiation terms
creating meta-data, like keywords and key requirements, related to this new service or scenario
sending this meta-data to the network to be stored in the Service and Scenario Registration blocks in each Service Exchange Agent system, providing distributed search resources

4. The Service Exchange Agent system of claim 1 further comprising the Service Knowledge Mapping block, which enables:
semantic association or mapping of multiple types of data to a related service or a scenario
structured navigation across business domains and service descriptions, like business and system requirements provided with human readable language as well as with XML, architecture diagrams and models, design patterns and other technical artifacts

5. The Service Exchange Agent system of claim 1 further comprising the Service and Scenario Composition block, which in collaboration with the Service Exchange Manager enables:
a conversational dialog to:
a requestor to retrieve requirements that might consist of text descriptions, design pattern names, and other technical artifacts
the Service Knowledge Mapping block to interpret and associate requirements and other descriptions or technical artifacts to existing services and business rules
transformation of incoming and associated data into formatted service invocations and business rules, while composing of a new service or a scenario, which consists of service invocations and business rules understood by a targeted service execution engine
saving a composed service or a scenario
registration of newly composed service or a scenario
sending meta-data, like keywords and key requirements, related to this new service or scenario, to the network for all Service Exchange Agent systems

6. The Service Exchange Agent system of claim 1 further comprising the Service Execution Engine, which enables:
in collaboration with the Service Exchange Manager receiving necessary information about a service or scenario for execution
arranging a conversational dialog to a requestor or other Service Exchange Agent systems that might own some services from a scenario for execution and can provide details on scenario fragments
parsing the scenario and in collaboration with the Service Knowledge Mapping block resolving scenario fragments into service calls and business logics, while replacing run-time variables with run-time values

7. The Service Exchange Agent system of claim 1 further comprising the Service Negotiation block, which:
stores service terms, including desired service value ranges, provided by a registrar;
stores a history of service requests and negotiations;
upon each request, re-calculates service values based on service requests, service terms, and history of negotiations;
in collaboration with the Service Exchange Manager converses with the service requestor and service owners while negotiating service terms upon service request;
after pre-defined number of unsuccessful negotiation cycles, notifies subject matter experts with invitation to participate and resolve negotiation issues

8. The Service Exchange Manager of claim 2 further comprising Initiation Ser vices, which enable structured access to services in multiple business domains, service offering, registration, subscription, and execution, consumption, and composition, as well as negotiation of service terms

9. The Initiation Services of claim 8 further comprising but not limited to basic services, like “List Services”, “Search for a Service”, “Subscribe to a Service”, “Load a Service”, “Execute a Service”, “Assemble a new service or scenario”, “Register a Service”, etc., which in collaboration with the Service Exchange Manager enable a conversation to a requester and other Service Exchange Agents to retrieve necessary information and satisfy service exchange requests from beginning-to-end; for example,
the “List Services” enables a conversation with a requestor to narrow down the area of requestor interests, starting from business domain names and reveals the main requestor's interest factors that might include service requirements, design patterns, or other business or technical considerations captured in the Service Knowledge Mapping block;
the “Subscribe to a Service” enables the conversation, which will retrieve the Customer Data, including, for example, but not limited to desired service execution location, specific service data, and scheduling information;

10. The Service Exchange Manager of claim 2 further comprising the Collaborative Work Controller, which enables collaborative work within the Service Exchange Agent system and with other Service Exchange Agents and subject matter experts, for example, when not all components of a requested service or a scenario can be found within a single Service Exchange Agent system

11. The Collaborative Work Controller of claim 10 further comprising Collaborative Work Coordinator criteria, which enable assigning one of the systems a system coordinator, based on criteria, for example, based on relevance to a business domain of a requested service scenario or based on a current system load, where the coordinator system is responsible for initiation and support of conversations and negotiations while in collaborative work with other Service Exchange Agent systems

12. The Service and Scenario Registration block of claim 3 further comprising the Service and Scenario Register Manager and collection blocks, which include for example, but not limited to:
Collector of Technical Artifacts that Reflect Multiple Views, like Design Patterns and Models, Business, Process, and Services diagrams, etc.,
Business Rules Collector,
Invocation Data Collector, Descriptions Collector, etc.,
where each collector block in collaboration with the Service and Scenario Register Manager enables:
data collection in a conversational mode;
interactions with the Service Knowledge Mapping block for data interpretation, translation into proper formats, for example, into formatted business rules, and association or mapping data to a registered service;
checking collected data against collector block's rules and criteria;
reporting inconsistency or rule violation to the Service Exchange Manager, which generates and sends to the registrar party a more precise information request that focuses on problematic data

13. The Service Knowledge Mapping block of claim 4 further comprising:
the Service Knowledge Mapping Controller,
the Service and Scenario Knowledgebase,
the Business Domain Maps,
the Integrity Checker,
i. where the Service Knowledge Mapping Controller enables interactions between the Service and Scenario Knowledgebase, the Business Domain Maps, the Integrity Checker, and major Service Exchange Agent system blocks,
ii. the Service and Scenario Knowledgebase enables storage of service descriptions and multiple other artifacts, and provides their mapping with natural language based associative rules;
iii. the Service and Scenario Knowledgebase in collaboration with the Service Knowledge Mapping Controller and the Service Exchange Manager enables conversational dialog with natural language elements between the Service Exchange Agent system blocks and subject matter experts or other Service Exchange Agent systems;
iv. the Business Domain Maps block defines business domains of registered services, for example, in the Topic Maps format, and enables conversational structured access to services by providing to distributed Service Exchange Agent systems meta-data about business domain and brief descriptions of related services;
v. the Integrity Checker enables checking of data association consistency and it is triggered each time when a new rule or association is stored;
vi. if one association or a rule is in conflict with another association or a rule, the Integrity Checker reports to the Service Knowledge Mapping Controller and back to the Service Exchange Manager, which communicates to another party a message that will focus on a problem area to retrieve more data to resolve a conflict

14. The Scenario and Service Composition block of claim 5 further comprising:
the Assembly Manager,
the Requirements Collector,
the Composite Service Assembler,
the Business Rules Assembler;
where:
the Assembly Manager enables interactions between the Requirements Collector, the Composite Service Assembler, the Business Rules Assembler, and other blocks of the Service Exchange Agent system, like the Service Exchange Manager, and the Services Knowledge Mapping block;
the Requirements Collector, in collaboration with the Assembly Manager, enables collection of requirements and separation of description information from invocation data and business rules;
the Composite Service Assembler, enables transformation of invocation data into properly formatted composite service scenario that can include business rules or references to business rules and can be executed by the targeted service execution engine;
the Business Rules Assembler, enables transformation of business logics descriptions into properly formatted business rules

15. The Business Rules Assembler of claim 14 enables association or integration of new rules with the existing set of rules in the Service and Scenario Knowledgebase and in collaboration with the Integrity Checker of claim 13 enables checking of data association consistency

16. The Service Exchange Agent system of claim 1 further comprising the Service Execution Engine, which enables parsing the composite service scenario and in collaboration with the Service Knowledge Mapping block resolving scenario fragments into service calls and business logics, while replacing run-time variables with run-time values and executing services and service scenarios

17. The Service Exchange Agent system of claim 1 further comprising the Service Negotiation block, which enables:
saving service terms, including desired service value range;
tracking service requests and calculation of service values based on demand, service terms, and previous negotiations;
negotiations of service terms and values, where it starts with rule-based computerized negotiations between Service Exchange Agents, and after pre-defined number of negotiation cycles, the Service Exchange Agent coordinator system will send a request to subject matter experts to participate and resolve the issues
